(19) United States
(12) Patent Application Publication
(10) Pub. No.: US 2017/0149306 A1
(43) Pub. Date: May 25, 2017

(54) PET Electricity Turbine Vortex Force Reactor

(71) Applicant: GREGORY STUART GORDON, WASHINGTON, DC (US)

(72) Inventor: GREGORY STUART GORDON, WASHINGTON, DC (US)

(21) Appl. No.: 14/923,334

(22) Filed: Oct. 26, 2015

(51) Int. Cl. H02K 7/18

(52) U.S. Cl. CPC H02K 7/1823; F03B 17/061

(57) ABSTRACT

A Perpetual Electricity Turbine Vortex Force Reactor is an apparatus for creating “green” electricity by tapping the full power potential of a recirculating liquid vortex of any size. This is done by redirecting the continuous explosion of the liquid escaping through the hole in the vortex chamber into a flywheel turbine attached to electrical generators. The liquid is then recirculated by a pump in a bottom liquid tank back up to the Vortex Chamber to create a self contained power system that does not pollute and is eligible for inclusion as an electrical power source under the net metering laws of many States, Florida in particular. Since the system is size independent very small single device powering reactors are possible as are enormous reactors that can power industrial size generators. Once the machines are in wide spread use the reactors will help to reduce America's carbon footprint by replacing the need for fossil fueled electric generators.

### CROSS REFERENCE TO RELATED APPLICATIONS

This RPA claims benefit of PPA No. 62/068,942

### BACKGROUND

This application relates to perpetual motion water vortex electricity generators. The use of carbon based fuels such as coal, oil and natural gas to generate electricity emits harmful pollutants into the atmosphere and injures the health of Americans. In addition, relying on foreign sources of these fuels often compromises our national interests. Finding ways to lower America's overall carbon footprint, while maintaining our high standard of living is of paramount concern to environmentalists, industrialists, and the media. Thankfully, our politicians have listened. 43 States and the District of Columbia have enacted Net Metering Laws that require public utilities to buy back “Green” electricity produced by consumers at the retail rate. These Net Metering Laws open us up to the possibility of massive amounts of localized electricity production that does not pollute.

Solar Panels have until now been the preferred method of producing “Green” residential electricity. The problem with solar panels however, is the high cost of installation and resulting high price per kilowatt hour of electricity produced. Even given the high cost of a solar panel installation, they do pay for themselves over a long period of time. Lowering the initial cost of home produced electricity would serve to fulfill the promise of current public policy and the Net Metering Laws. Fortunately, some of the State Net Metering laws allow for alternative electricity producing technologies other than solar panels.

It has been established at least in theory that a perpetual motion machine that taps the Earth's Coriolis Effect by means of a water vortex and produces more electricity than it uses is possible. Several U.S. and foreign patent applications have been approved that claim benefit of this means of energy production.

### BACKGROUND PRIOR ART

Chinese patent CN 103899468 A is a water turbine power station is designed to be used in rivers and streams. Unlike a PET it requires a specific location where there is a running stream or river.

U.S. Pat. No. 5,336,933 is a Vortex power generating apparatus that can be used in air or water. That uses sails to tap the vortex. It is not as efficient as a PET.

Patent WO 2010121355 Describes a mini hydro plant having a recirculating water design. Herein the vortex is tapped by a system of rotors provided with fins. The fins obstruct the full vortex potential.

### SUMMARY

A PET—Perpetual Electricity Turbine Vortex Force Reactor is a machine based upon a simple vortex force reactor that uses no obstructions within a Vortex chamber. This allows us to tap the full potential of the water flowing through a vortex. The best way to understand the reactor is to think of an internal combustion engine where a spark plug ignites fuel which explodes and pushes down a piston. After the vortex has formed in the vortex chamber water or liquid is ejected and explodes continually sideways out of the chamber's central bottom hole. This water or liquid is redirected by an angled skirt or nozzle down through a flywheel turbine which spins the connected generators thus producing electricity.

### DRAWINGS

FIG. 1 is a side view cut away drawing of a large PET showing the internal workings

FIG. 2 is a cut away side view of the angled skirt around the hole to redirect the vortex fluid

FIG. 3 is a view of the angled skirt from the bottom showing the bearings holder

FIG. 4 is a top down view of the Large PET control room showing generators, turbine and controls

FIG. 5 is a top down cut away view of the motion of the fluid in the Vortex Chamber

FIG. 6 is a cut away side view of an extra-large PET showing the inner workings.

FIG. 7 is a cut away side view of the movement of the vortex fluid through the reactor turbine.

FIG. 8 is a partial cutaway view of a homemade PET known as The Electric Cans

FIG. 9 is a partial cutaway view of a PET Lamp.

### DRAWINGS LIST OF REFERENCE NUMERALS

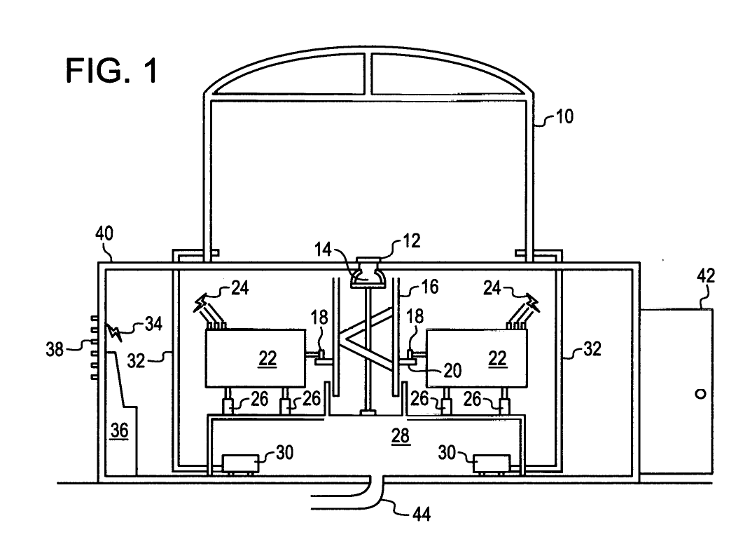

FIG. 1 Cut Away Drawing of Large PET
10 Vortex Chamber Tank
12 Water Stop Plug
14 Water redirecting angled hole skirt or nozzle
16 Spiral style Flywheel turbine
18 Generator Powering Wheels
20 Generator Wheel Turbine Track
22 Generators
24 Electric lines out to controls
26 Hydraulic power on off lifts
28 Return Water Tank
30 Water Recycle pump
32 Water recycle hose or pipe
34 Electric lines into controls
36 Electronic Controls
38 Cooling vents
40 Superstructure heavy load bearing-
42 Security door
44 Water drain pipe

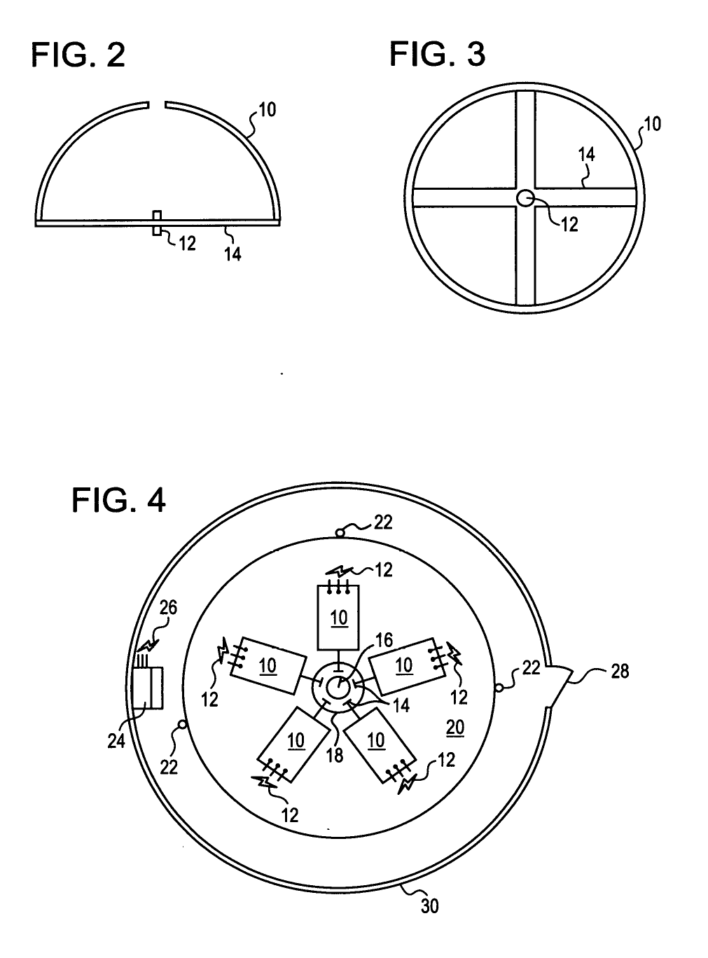

FIG. 2 Angled Skirt for Hole
10 Angled Skirt
12 Turbine bearings.
14 Arms to support turbine bearings.

FIG. 3 Angled Skirt from the Bottom
10 Angled skirt bottom
12 Turbine bearings space
14 Arms to support bearings space

FIG. 4 Large PET Control Room
10 Generators
12 Electric lines out to controls
14 Generator powering wheels
16 Spiral style Flywheel Turbine
18 Turbine track
20 Return Water Tank
22 Water Recycle Return Pump
24 Electronic Controls
26 Wires into Electronic Controls
28 Solid Steel Security Door
30 Support Structure Walls

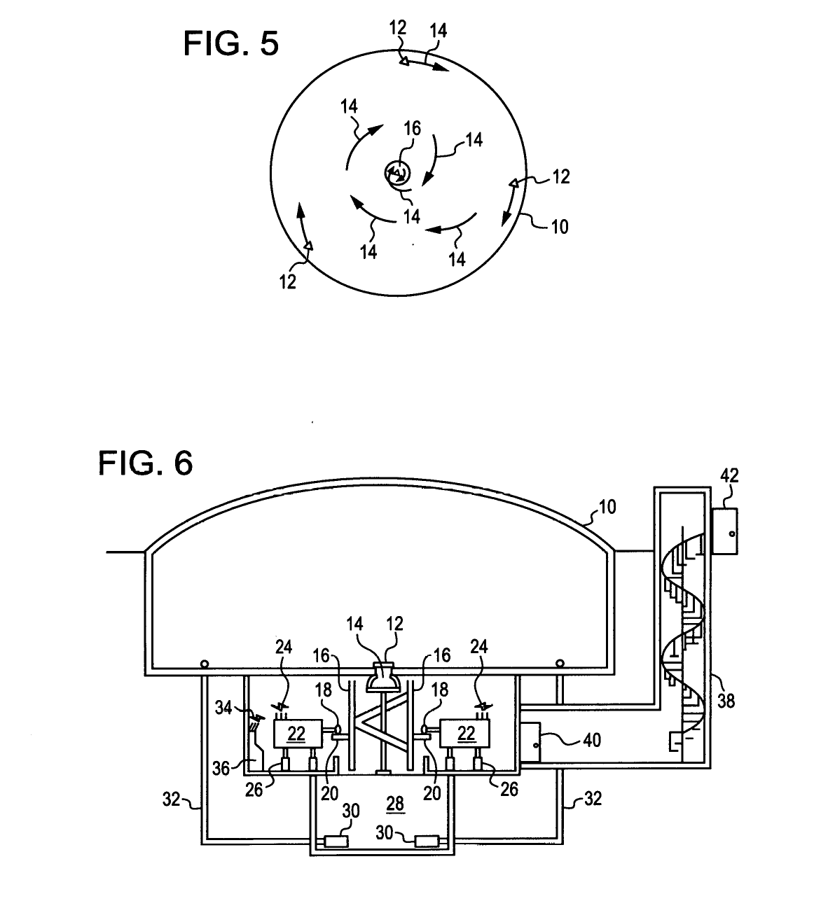

FIG. 5 Vortex Chamber Water Flow from Above
10 Chamber Wall
12 Return water nozzle showing direction for north hemisphere
14 Direction of water flow
16 Hole

FIG. 6 Extra Large Swirlpool PET
10 Domed Swirlpool Vortex Chamber
12 Plug for Tank
14 Angled Skirt or Nozzle
16 Screw Style Flywheel Turbine

18 Generator Wheels
20 Generator Track
22 Generator
24 Line out to Controls
26 Hydraulic on off lift
28 Return Water Tank
30 Return Water Pump
32 Return Water Hose or Pipe
34 Line into Controls
36 Electronic Controls
38 Stairs down to control room
40 Stairway door

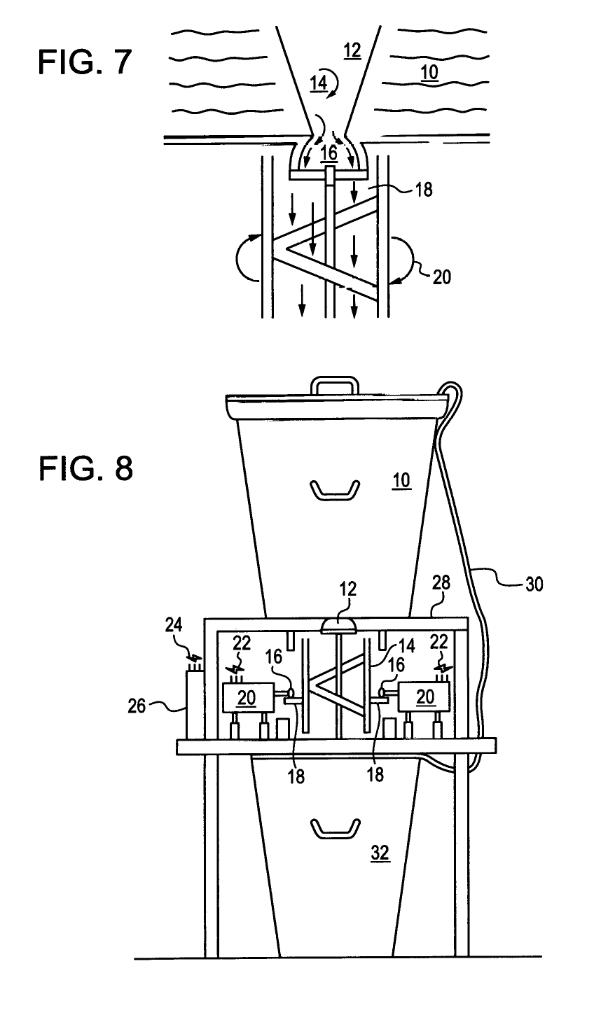

FIG. 7 Movement of Water Flow through Reactor Turbine
10 Body of Water Swirling
12 Vortex
14 Water Swirling Down
16 Water ejected and redirected by Angled Skirt or Nozzle
18 Water pouring down
20 Direction of Spinning Turbine.

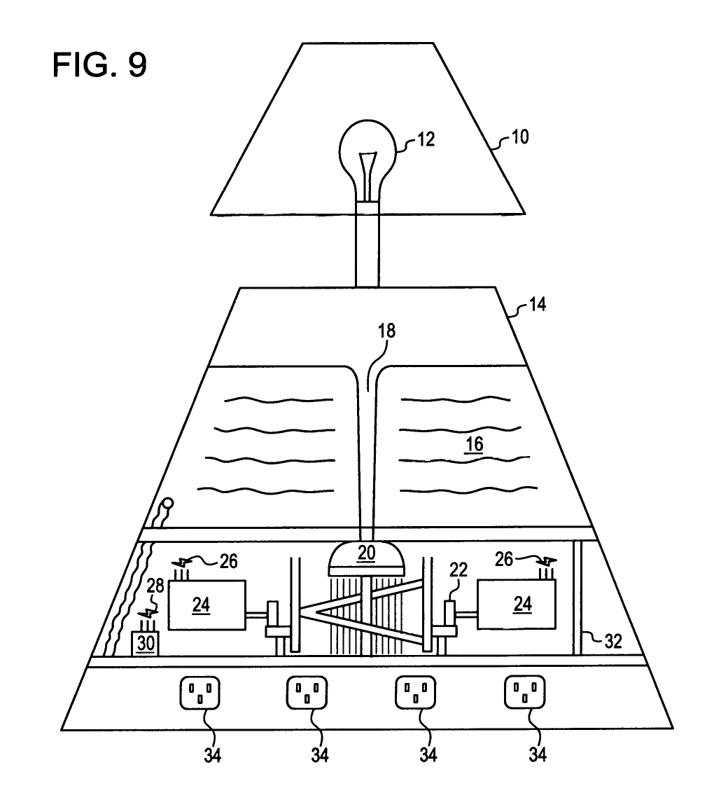

FIG. 8 Electric Cans
10 Top Vortex Chamber Can
12 Angled Skirt or Nozzle
14 Flywheel Turbine
16 Generator Wheels
18 Generator Wheel Track
20 Generators
22 Power lines out to Controls
24 Power lines into controls
26 Electronic controls
28 Wooden Support Structure
30 Return Water Hose
32 Bottom Return Water Can

FIG. 9 PET Light—Just add Water
10 Lamp Shade
12 LED Bulb
14 Lamp Vortex Chamber
16 Swirling Water
18 Vortex
20 Angled Skirt or Nozzle
22 Screw Style Turbine Flywheel
24 Generator
26 Line out to controls
28 Line into controls
30 Controls
32 Return line from Return tank
34 Auxiliary electric Plugs

### DETAILED DESCRIPTION LARGE PET FIGS. 1-4

FIG. 1—Top 200—10,000 gallon Circular Vortex Chamber part number 10 has a hole in the middle of the bottom which is plugged by a plug part number 12. The hole is surrounded by an angled skirt or water deflecting nozzle part number 14 that directs water from a horizontal route downward. The deflecting nozzle has a built-in hole or support for the bearings of a Spiral Style Flywheel Turbine part number 16. The turbine has a built in track that runs around the perimeter part 20 that supports generator wheels part 18 that are attached to generators part 22. Electric power lines part 24 run from the generators to an electronics controller. Each Generator is supported by hydraulic or other lifts part 26 that can put the generator wheels on or off of the generator track. The turbine sits above a return water tank part number 28. Water from the return water tank is recirculated to the top vortex chamber by Water Recycle pump part 30 through the water return hose or pipe part 32. Electricity is sent from generators into the electronic controls part number 36 through the power lines part number 34. Part 38 represents cooling vents for the building. Part 40 is the superstructure of the building itself this holds up the Vortex Chamber and seals in the generators and other operating parts from the weather. Part 42 represents solid steel security doors for the building to keep the machine safe and people safe from the moving machine parts. Part 44 is the water drain pipe out of the building area.

FIG. 2 Represents a side view of the angled skirt around the top vortex chamber. Part 10 is the actual angled skirt. Part 12 shows the turbine bearings and part 14 shows the struts or crossbeams that support the bearing holder.

FIG. 3 is a bottom view of the angled Skirt. Showing part 10 the actual ring or circular nature of the skirt. Part 12 shows where the bearings are held and part 14 are the crossbeams that support the bearings.

FIG. 4 shows the control room from above and shows the spatial layout of the generators part 10 with relation to the flywheel turbine and turbine track parts 16 and 18, as well as the outline of the bottom water tank part 20 and water return pipes part 22.

### Operation of Large Pet FIGS. 1, 5, 7.

The operation of all Perpetual Electricity Turbines is basically the same. Simply add water pull the plug, start the return water pump and the machine generates more electricity than it uses.

Fill the top vortex chamber FIG. 1 part 10, FIG. 5 part 10 with water or other fluid. Then pull the plug FIG. 1 part 12 and turn on return water pump FIG. 1 part 30. This starts the Vortex Force Reaction. Soon the water in the top tank will turn into a vortex FIG. 7 number 12 and the water coming through the hole will stop streaming straight down and come down in a circular motion FIG. 7 number 14 thus being ejected sideways as the water exits the hole. The angled skirt will change the exploding water from a sideways direction and send it back straight down FIG. 7 number 16 where it will hit the surface of Spiral shaped “blades” of the turbine FIG. 7 number 18. This will start the turbine spinning FIG. 7 number 20. The turbine will spin slowly at first due to its heavy weight as it is designed to be a flywheel. The slower it starts the more power it will produce once up to speed. Once the turbine has reached a good speed the generator wheels are lowered unto the generator wheel track and the generators will begin to produce more electricity than required to operate the water return pump FIG. 1 part 30. Excess electricity is sent to the electronic controls through FIG. 1 part 24 and into the controls FIG. 1 part 34. The electronic controls FIG. 1 part 36 conditions the electricity for feeding into the electric grid.

### Other Embodiments of the Perpetual Electricity Turbine FIGS. 6, 8 and 9.

The mechanical parts required to operate the PET are the same no matter what size the Reactor. Water in the top Vortex Chamber is released into the turbine then the return water pump starts to recirculate the water or other fluid which starts to spin the turbine. After the turbine has generated a good speed the generator wheels are put into contact with the generator track thus generating electricity.

Electricity produced by the generators can go directly to operating the return water pump and any other device that is either directly attached to the PET such as in FIG. 9 where the PET is actually a lamp. FIG. 9 also shows optional electric plugs to plug in auxiliary devices. Any device that requires electricity can contain a PET as its power source. FIG. 6 is of a very large PET. The tank size can be anywhere from 10,000 gallons on up. Since it is very large it is designed as a “Swirlpool” to be put in the ground and built like a swimming pool with the control room and return tank built-in below the bottom of the top Vortex Chamber.

The materials used to construct the parts of the vortex reactor are up to the individual. Plastic or other non-conducting material can be used for the Vortex Chamber and carbon fiber may be used for the Flywheel Turbine just for extra added safety.

The weight of the flywheel turbine should be great enough to overcome the torque requirements of the generators. To be certain of this the weight of the flywheel turbine should be greater than the weight of the generators.

The size of the hole through which the water passes will depend upon the size of the Vortex Chamber. The size of the hole will vary from a quarter inch or less up to one or two feet or more wide. For example, a test model sustained a vortex within a five gallon vortex chamber with a one inch hole using a pump which circulated 84 gallons of water per hour. Due to the self-sealing nature of the vortex the amount of water circulating through is independent of the size of the hole and dependent upon the amount of water coming from the return water pump.

### ADVANTAGES

The PET method and apparatus for producing electricity from a water or other fluid vortex is much simpler and more powerful than other ways of tapping a water vortex to make electricity and it is completely independent of size.
1. A PET can produce electricity 24 hours a day 365 days a year. Independent of sunshine or wind.
2. A PET is cheaper than a solar panel system or wind powered system of the same wattage.
3. A PET is independent of location. It can be inside or outside and used in any climatic situation.
4. A properly sized PET can produce income for its owner through current net metering laws.
5. Once established as a common source of power PETs will reduce America's carbon footprint.
6. A PET runs silently and does not make noise as does a gasoline or diesel powered generator.
7. By plugging the return water pump into the electricity generators a PET can also be used for totally off-grid power generation.

### CONCLUSION, RAMIFICATIONS AND SCOPE

Thus the reader will see that at least one embodiment of the PET, Perpetual Electricity Turbine Vortex Force Reactor is cheaper, more independent of location and more versatile than other renewable energy sources such as wind powered turbines or solar panels. A PET can be used with net metering laws for sending energy back into the grid and selling power back to the local electric company or can be used totally off-grid for stand alone electric power.

While my above description contains many specificities, these should not be construed as limitations on the scope, but rather as an exemplification of several embodiments therof. Many other variations are possible such as a radial saw or other device which is powered by connecting to the Flywheel Turbine directly via a belt or chain and bypassing the generation of electricity all together.

Very small PETs can be used to power small electronic devices such as cell phones and laptop computers. Extremely large PETs can be used to power huge generators such as the ones at Hoover Dam or any other large Dam. PETs can also be used to retrofit the generators in Coal fired or Nuclear powered power plants. A series of extra large PETs could actually power the world's largest generators such as the Tocamak Generator in the United Kingdom thus eliminating the threat of a global melt down should a fusion reactor's magnetic shield fail.

Accordingly, the scope of the embodiments should be determined by the appended claims and their legal equivalents rather than by the examples given.

1. A machine capable of tapping the energy from the continuous explosion of water or a liquid after it runs through a vortex and is ejected through a hole comprising:
an angled skirt or nozzle surrounding the bottom hole of an unlimited sized cylindrical vortex chamber to redirect the explosion of liquid escaping from the hole from horizontal to downward vertical and into a turbine
a hole in said skirt or nozzle within crossbeams for holding the top bearings of the turbine
a means for coupling the rotational energy of the turbine to an electricity generator or plurality of electric generators.
a return water reservoir and pump to recirculate the liquid after it passes through the turbine back to the top vortex chamber.
